(19) United States
(12) Patent Application Publication
(10) Pub. No.: US 2014/0329681 A1
(43) Pub. Date: Nov. 6, 2014

(54) METHOD FOR CONTROLLING WEEDS IN SUGAR CANE FIELD

(71) Applicant: SUMITOMO CHEMICAL COMPANY, LIMITED, Tokyo (JP)

(72) Inventor: Hajime Ikeda, Kasai-shi (JP)

(21) Appl. No.: 14/364,866

(22) PCT Filed: Dec. 7, 2012
(86) PCT No.: PCT/JP2012/082431

§ 371 Date: Jun. 12, 2014

(30) Foreign Application Priority Data
Dec. 15, 2011 (JP) 2011-274148

(51) Int. Cl. A01N 57/20; A01N 43/70; A01N 43/50; A01N 43/66; A01N 43/653; A01N 43/707; A01N 47/38

(52) U.S. Cl. CPC A01N 57/20; A01N 43/707; A01N 43/70; A01N 47/38; A01N 43/66; A01N 43/653; A01N 43/50
USPC 504/206; 504/229; 504/234; 504/217; 504/231; 504/273; 504/253

(57) ABSTRACT

The present invention relates to a method for controlling weeds in a sugar cane field, including applying to a field before or after planting stem cuttings of sugar cane having only one node, at least one herbicide selected from the group consisting of ametryn, atrazine, simazine, alachlor, metolachlor, S-metolachlor, asulam, metribuzin, trifluralin, pendimethalin, tebuthiuron, diuron, hexazinone, amicarbazone, imazapic, trifloxysulfuron-sodium, iodosulfuron-methyl-sodium, halosulfuron-methyl, ethoxysulfuron, carfentrazone-ethyl, isoxaflutole, bicyclopyrone, mesotrione, picloram and salts thereof and esters thereof, 2,4-D and salts and esters thereof, dicamba and salts and esters thereof, clomazone, MSMA, paraquat, diquat, glufosinate, glufosinate-ammonium, glufosinate-P and salts thereof, and glyphosate and salts thereof.

The present invention provides an excellent effect of controlling weeds without causing phytotoxicity problematic to sugar cane in a sugar cane field. The present invention can also increase the yield of sugar cane to increase the amount of sugar produced.

### TECHNICAL FIELD

The present invention relates to a method for controlling weeds.

### BACKGROUND ART

To control weeds, many compounds have been known as active ingredients in pest control agents such as herbicides.

### PRIOR ART DOCUMENTS

### Patent Documents

Patent Document 1: WO009/000398
Patent Document 2: WO09/000399
Patent Document 3: WO09/000400
Patent Document 4: WO09/000401
Patent Document 5: WO09/000402
Patent Document 6: WO2011/008453

### Non-Patent Document

Non-Patent Document 1: Crop Protection Handbook, vol. 95 (2009)

### SUMMARY OF THE INVENTION

### Problems to be Solved by the Invention

It is an object of the present invention to provide a method which exerts an excellent effect of controlling weeds in a sugar cane field without causing phytotoxicity problematic to sugar cane.

### Means for Solving the Problems

The present invention is such that application of a certain herbicide(s) to a field where stem cuttings of sugar cane having a specific length are planted exerts an excellent effect of controlling weeds growing in the field without causing phytotoxicity problematic to sugar cane.

The present invention is as follows.

[1] A method for controlling weeds in a sugar cane field, comprising applying at least one herbicide selected from the group consisting of ametryn, atrazine, simazine, alachlor, metolachlor, S-metolachlor, asulam, metribuzin, trifluralin, pendimethalin, tebuthiuron, diuron, hexazinone, amicarbazone, imazapic, trifloxysulfuron-sodium, iodosulfuron-methyl-sodium, halosulfuron-methyl, ethoxysulfuron, carfentrazone-ethyl, isoxaflutole, bicyclopyrone, mesotrione, picloram and salts thereof and esters thereof, 2,4-D and salts and esters thereof, dicamba and salts and esters thereof, clomazone, MSMA, paraquat, diquat, glufosinate and salts thereof, glufosinate-P and salts thereof, and glyphosate and salts thereof,

to a field before or after planting stem cuttings of sugar cane having only one node.

[2] The method for controlling weeds in a sugar cane field according to [1], wherein the stem cuttings of sugar cane have a length of from 2 cm to 15 cm.

[3] The method for controlling weeds in a sugar cane field according to [1], wherein the stem cuttings of sugar cane have a length of from 3 cm to 8 cm.

### Effect of the Invention

The method of the present invention can control weeds in a sugar cane field without causing phytotoxicity problematic to sugar cane.

The method of the present invention can also increase the yield of sugar cane to increase the amount of sugar produced.

### MODE FOR CARRYING OUT THE INVENTION

The method for controlling weeds according to the present invention includes the steps of:

(1) planting stem cuttings of sugar cane having a specific length; and

(2) applying a herbicide containing at least one compound selected from the group consisting of ametryn, atrazine, simazine, alachlor, metolachlor, S-metolachlor, asulam, metribuzin, trifluralin, pendimethalin, tebuthiuron, diuron, hexazinone, amicarbazone, imazapic, trifloxysulfuron-sodium, iodosulfuron-methyl-sodium, halosulfuron-methyl, ethoxysulfuron, carfentrazone-ethyl, isoxaflutole, bicyclopyrone, mesotrione, picloram and salts thereof and esters thereof, 2,4-D and salts and esters thereof, dicamba and salts thereof and esters thereof, clomazone, MSMA, paraquat, diquat, glufosinate and salts thereof, and glyphosate and salts thereof.

Sugar cane used in the method of the present invention is a perennial gramineous crop in the genus Saccharum, and examples thereof include Saccharum arundinaceum, Saccharum bengalense, Saccharum edule, Saccharum officinarum, Saccharum procerum, Saccharum ravennae, Saccharum robustum, Saccharum sinense, Saccharum spontaneum, and hybrids of these species.

Sugar cane used in the method of the present invention is not limited as long as being a variety which is usually cultivated as a crop.

Examples of the crop include plants having resistance, imparted by classical breeding methods or genetic engineering techniques, to herbicides such as 4-hydroxyphenylpyruvate dioxygenase inhibitors such as isoxaflutole; acetolactic acid synthetase (hereinafter, abbreviated as ALS) inhibitors such as imazethapyr and thifensulfuron-methyl; 5-enolpyruvylshikimate-3-phosphate synthase (hereinafter, abbreviated as EPSP) inhibitors such as glyphosate; glutamine synthetase inhibitors such as glufosinate; auxin-type herbicides such as 2,4-D, and dicamba; and bromoxynil.

The crops also include, for example, crops which are genetically engineered to synthesize a selective toxin known in the genus Bacillus and the like.

Examples of toxins expressed in such genetically engineered plants include insecticidal proteins derived from Bacillus cereus or Bacillus popilliae; δ-endotoxins such as Cry1Ab, Cry1Ac, Cry1F, Cry1Fa2, Cry2Ab, Cry3A, Cry3Bb1, and Cry9C, and insecticidal proteins such as VIP1, VIP2, VIP3, and VIP3A, the δ-endotoxins and insecticidal proteins being derived from Bacillus thuringiensis; insecticidal proteins derived from nematodes; toxins produced by animals, such as scorpion toxins, spider toxins, bee toxins, and insect-specific neurotoxins; toxins of filamentous fungi; plant lectins; agglutinin; protease inhibitors such as trypsin inhibitors, serine protease inhibitors, patatin, cystatins, and a papain inhibitor; ribosome inactivating proteins (RIP) such as lysine, maize-RIP, abrin, luffin, saporin, and bryodin; steroid metabolic enzymes such as 3-hydroxysteroid oxidase, ecdysteroid-vDP-glucosyltransferase, and cholesterol oxidase; ecdysone inhibitors; HMG-CoA reductase; ion channel inhibitors such as sodium channel and calcium channel inhibitors; juvenile hormone esterase; diuretic hormone acceptors; stilbene synthase; bibenzyl synthase; chitinases; and glucanases.

Examples of toxins expressed in such genetically engineered crops include hybrid toxins, partially deleted toxins, and modified toxins of δ-endotoxin proteins such as Cry1Ab, Cry1Ac, Cry1F, CrylFa2, Cry2Ab, Cry3A, Cry3Bb1, Cry9C, Cry34Ab, and Cry35Ab, and insecticidal proteins such as VIP1, VIP2, VIP3, and VIP3A. The hybrid toxins are produced by new combination of different domains of these proteins using genetic engineering techniques. As the partially deleted toxin, Cry1Ab in which an amino acid sequence is partially deleted has been known. In the modified toxins, one or more amino acids of naturally occurring toxins are substituted. Examples of these toxins and genetically engineered plants which can synthesize these toxins are described in EP-A-0374753, WO093/07278, WO 95/34656, EP-A-0427529, EP-A-451878, WO 03/052073, and the like. The toxins included in such genetically engineered plants impart resistance particularly against Coleoptera pests, Dipterous pests, and Lepidopterous pests to the plants.

The crops also include crops to which the ability to produce anti-pathogenic substances having a selective action is imparted using genetic engineering technique. As examples of the anti-pathogenic substance, PR proteins and the like are known (PRPs, EP-A-0392225). Such anti-pathogenic substances and genetically engineered plants producing the anti-pathogenic substances are described in EP-A-0392225, WO 95/33818, EP-A-0353191, and the like. Examples of the anti-pathogenic substances expressed in such genetically engineered plants include ion channel inhibitors such as sodium channel inhibitors, and calcium channel inhibitors (for example, KP1, KP4, and KP6 toxins produced by viruses are known); stilbene synthase; bibenzyl synthase; chitinases; glucanases; PR proteins; anti-pathogenic substances produced by microorganisms, such as peptide antibiotics, heterocyclic antibiotics, and protein factors involved in plant disease-resistance (called plant disease resistance genes and described in WO 03/000906).

The crops also include crops to which disease resistance, drying stress resistance, a trait of increased sugar content, or the like is imparted.

In cultivation of sugar cane, stern cuttings having a node(s), where which new stems, leaves, and roots will grow, are planted. In the method of the present invention, as stem cuttings of sugar cane, stem cuttings having one node are used. The size of the stem cutting of sugar cane is preferably from 2 cm to 15 cm long, more preferably from 3 cm to 8 cm long. Sugar cane cultivation techniques using such stem cuttings are known in Patent Documents 2 to 6, and also known as brand name Plene (trademark).

The stem cuttings of sugar cane used in the method of the present invention may be treated with a pesticide, a nematicide, a fungicide, a plant growth controlling agent, and a safener before planted.

Examples of other agrochemicals described above include the following substances:

Pesticides: clothianidin, thiamethoxam, imidacloprid, dinotefuran, nitenpyram, acetamiprid, thiacloprid, abamectin, fipronil, carbofuran.

Nematicide: fosthiazate.

Fungicides: kresoxim-methyl, azoxystrobin, trifloxystrobin, fluoxastrobin, picoxystrobin, pyraclostrobin, dimoxystrobin, pyribencarb, metominostrobin, orysastrobin, enestrobin, pyraoxystrobin, pyrametostrobin, azaconazole, bitertanol, bromuconazole, cyproconazole, difenoconazole, diniconazole, epoxiconazole, fenbuconazole, fluquinoconazole, flusilazole, flutriafol, hexaconazole, imibenconazole, ipconazole, metconazole, myclobutanil, penconazole, propiconazole, prothioconazole, simeconazole, tebuconazole, tetraconazole, triadimenol, triticonazole, fenarimol, nuarimol, pyrifenox, imazalil, oxpoconazole fumarate, pefurazoate, prochloraz, triflumizole, metalaxyl, and metalaxyl-M.

Plant growth controlling agents: hymexazol, paclobutrazol, uniconazole, uniconazole-P, inabenfide, prohexadione-calcium, 1-methylcyclopropene, trinexapac, and gibberellins.

Safeners: benoxacor, cloquintocet, cyometrinil, cyprosulfamide, dichlormid, dicyclonon, dietholate, fenchlorazole, fenclorim, flurazole, fluxofenim, furilazole, isoxadifen, mefenpyr, mephenate, naphthalic anhydride, and oxabetrinil.

Examples of the herbicide used in a sugar cane field in the method of the present invention include ametryn, atrazine, simazine, alachlor, metolachlor, S-metolachlor, asulam, metribuzin, trifluralin, pendimethalin, tebuthiuron, diuron, hexazinone, amicarbazone, imazapic, trifloxysulfuron-sodium, iodosulfuron-methyl-sodium, halosulfuron-methyl, ethoxysulfuron, carfentrazone-ethyl, isoxaflutole, bicyclopyrone, mesotrione, picloram and salts and esters thereof, 2,4-D and salts and esters thereof, dicamba and salts and esters thereof, clomazone, MSMA, paraquat, diquat, glufosinate and salts thereof, glufosinate-P and salts thereof, and glyphosate and salts thereof.

Specific examples of the salt or ester of picloram include picloram-2-ethylhexyl, picloram-isooctyl, picloram-methyl, picloram-olamine, picloram-potassium, picloram-triethylamine, and picloram-tris(2-hydroxypropyl)amine.

Specific examples of the salt or ester of 2,4-D include 2,4-D-ammonium, 2,4-D-butotyl, 2,4-D-2-butoxypropyl, 2,4-D-3-butoxypropyl, 2,4-D-butyl, 2,4-D-diethylamine, 2,4-D-dimethylamine, 2,4-D-diolamine, 2,4-D-dodecylamine, 2,4-D-ethyl, 2,4-D-2-ethylhexyl, 2,4-D-heptylamine, 2,4-D-isooctyl, 2,4-D-isopropyl, 2,4-D-isopropylamine, 2,4-D-lithium, 2,4-D-meptyl, 2,4-D-methyl, 2,4-D-octyl, 2,4-D-pentyl, 2,4-D-propyl, 2,4-D-sodium, 2,4-D-tefuryl, 2,4-D-tetradecylamine, 2,4-D-triethylamine, 2,4-D-tris(2-hydroxypropyl)amine, 2,4-D-trolamine, and 2,4-D-choline.

Specific examples of the salt or ester of dicamba include dicamba-diglycolamine, dicamba-dimethylamine, dicamba-diolamine, dicamba-isopropylamine, dicamba-methyl, dicamba-olamine, dicamba-potassium, dicamba-sodium, dicamba-trolamine, and dicamba-choline

Specific examples of the salt of glufosinate include glufosinate-ammonium.

Specific examples of the salt of glufosinate-P include glufosinate-P-sodium and glufosinate-P-ammonium.

Specific examples of the salt of glyphosate include glyphosate-isopropylamine, glyphosate-trimethylsulfonium, glyphosate-ammonium, glyphosate-diammonium, glyphosate-sodium, glyphosate-potassium, and glyphosate guanidine derivative salts described in Patent Document 6.

In the method of the present invention, the herbicide can be applied together with one or more other agrochemicals. Examples of the other agrochemicals include pesticides, miticides, nematicides, fungicides, herbicides, plant regulators, and safeners.

Examples of the herbicide among the other agrochemicals include the following substances:

MCPA and salts and esters thereof (dimethylammonium salt, 2-ethylhexyl ester, isooctyl ester, sodium salt, choline salt), MCPB, mecoprop and salts and esters thereof (dimethylammonium salt, diolamine salt, ethadyl ester, 2-ethylhexyl ester, isooctyl ester, methyl ester, potassium salt, sodium salt, trolamine salt, choline salt), mecoprop-P and salts and esters thereof (dimethylammonium salt, 2-ethylhexyl ester, isobutyl salt, potassium salt, choline salt), dichlorpropand salts or esters thereof (butotyl ester, dimethylammonium salt, 2-ethylhexyl ester, isooctyl ester, methyl ester, potassium salt, sodium salt, choline salt), dichlorprop-P, dichlorprop-P-dimethylammonium, bromoxynil, bromoxynil-octanoate, dichlobenil, ioxynil, ioxynil-octanoate, di-allate, butylate, tri-allate, phenmedipham, chlorpropham, phenisopham, benthiocarb, molinate, esprocarb, pyributicarb, prosulfocarb, orbencarb, EPTC, dimepiperate, swep, propachlor, metazachlor, acetochlor, butachlor, pretilachlor, thenylchlor, aminocyclopyrachlor, aminocyclopyrachlor-methyl, aminocyclopyrachlor-potassium, ethalfluralin, benfluralin, prodiamine, propazine, cyanazine, simetryn, dimethametryn, prometryn, indaziflam, triaziflam, isoxaben, diflufenican, linuron, fluometuron, difenoxuron, methyl-daimuron, isoproturon, isouron, benzthiazuron, methabenzthiazuron, propanil, mefenacet, clomeprop, naproanilide, bromobutide, daimuron, cumyluron, diflufenzopyr, etobenzanid, bentazon, tridiphane, indanofan, amitrole, fenchlorazole, maleic hydrazide, pyridate, chloridazon, norflurazon, bromacil, terbacil, oxaziclomefone, cinmethylin, benfuresate, cafenstrole, pyrithiobac, pyrithiobac-sodium, pyriminobac, pyriminobac-methyl, bispyribac, bispyribac-sodium, pyribenzoxim, pyrimisulfan, pyriftalid, fentrazamide, dimethenamid, dimethenamid-P, ACN, benzobicyclon, dithiopyr, triclopyr and salts and esters thereof (butotyl ester, triethylammonium salt), fluoroxypyr, fluoroxypyr-meptyl, thiazopyr, aminopyralid and salts thereof (potassium salt, triisopanolammonium salt, choline salt), clopyralid and salts thereof (olamine salt, potassium salt, triethylammonium salt, choline salt), dalapon, chlorthiamid, amidosulfuron, azimsulfuron, bensulfuron, bensulfuron-methyl, chlorimuron, chlorimuron-ethyl, cyclosulfamuron, flazasulfuron, flucetosulfuron, flupyrsulfuron, flupyrsulfuron-methyl-sodium, foramsulfuron, imazosulfuron, mesosulfuron, mesosulfuron-methyl, nicosulfuron, orthosulfamuron, oxasulfuron, primisulfuron, prirmisulfuron-methyl, propyrisulfuron, pyrazosulfuron, pyrazosulfuron-ethyl, rimsulfuron, sulfometuron, sulfometuron-methyl, sulfosulfuron, trifloxysulfuron, chlorsulfuron, cinosulfuron, ethametsulfuron, ethametsulfuron-methyl, metsulfuron, metsulfuron-methyl, prosulfuron, thifensulfuron, thifensulfuron-methyl, triasulfuron, tribenuron, tribenuron-methyl, triflusulfuron, triflusulfuron-methyl, tritosulfuron, picolinafen, beflubutamid, sulcotrione, tefuryltrione, tembotrione, isoxachlortole, benzofenap, pyrasulfotole, pyrazolynate, pyrazoxyfen, topramezone, flupoxam, bencarbazone, flucarbazone, flucarbazone-sodium, ipfencarbazone, propoxycarbazone, propoxycarbazone-sodium, thiencarbazone, thiencarbazone-methyl, cloransulam, cloransulam-methyl, diclosulam, florasulam, flumetsulam, metosulam, penoxsulam, pyroxsulam, imazamethabenz, imazamethabenz-methyl, imazamox, imazamox-ammonium, imazapic-ammonium, imazapyr, imazapyr-ammonium, imazaquin, imazaquin-ammonium, imazethapyr, imazethapyr-ammonium, clodinafop, clodinafop-propargyl, cyhalofop, cyhalofop-butyl, diclofop, diclofop-methyl, fenoxaprop, fenoxaprop-ethyl, fenoxaprop-P, fenoxaprop-P-ethyl, fluazifop, fluazifop-butyl, fluazifop-P, fluazifop-P-butyl, haloxyfop, haloxyfop-methyl, haloxyfop-P, haloxyfop-P-methyl, metamifop, propaquizafop, quizalofop, quizalofop-ethyl, quizalofop-P, quizalofop-P-ethyl, alloxydim, clethodim, sethoxydim, tepraloxydim, tralkoxydim, pinoxaden, pyroxasulfone, bialafos, anilofos, bensulide, butamifos, agriculturally acceptable salts thereof, and the like.

In the step of applying the herbicide to a sugar cane field, the herbicide is usually mixed with a carrier, such as a solid carrier and a liquid carrier, and an optional preparation auxiliary, such as a surfactant, to form a preparation before use.

Examples of a method for applying the herbicide to a sugar cane field include a method for spraying the herbicide on the soil of the field and a method for spraying the herbicide on weeds after weeds growing.

The amount of the herbicide used in the step of applying the herbicide to the field is usually 5 to 3,000 g per 10,000 m². In the step of applying the herbicide to the field, an adjuvant may be mixed upon application of the herbicide.

In the method of the present invention, the herbicide may be applied before planting the stem cuttings of sugar cane, or the herbicide may be applied after planting the stem cuttings of sugar cane.

When the herbicide is applied before planting the stem cuttings of sugar cane, the herbicide is applied from 40 days before to just before planting, preferably from 30 days before to just before planting, more preferably from 20 days before to just before planting.

When the herbicide is applied after planting the stem cuttings of sugar cane, the herbicide is applied from just after to 40 days after planting, preferably from just after to 20 days after planting, more preferably from just after to 10 days after planting.

The method of the present invention can control weeds in a sugar cane field.

Examples of the weeds include the following weeds:

Urticaceae weeds: Urtica urens

Polygonaceae weeds: Polygonum convolvulus, Polygonum lapathifolium, Polygonum pensylvanicum, Polygonum persicaria, Polygonum longisetum, Polygonum aviculare, Polygonum arenastrum, Polygonum cuspidatum, Rumex japonicus, Rumex crispus, Rumex obtusifolius, Rumex acetosa

Portulacaceae weeds: Portulaca oleracea

Caryophyllaceae weeds: Stellaria media, Cerastium holosteoides, Cerastium glomeratum, Spergula arvensis, Silene gallica

Molluginaceae weeds: Mollugo verticillata

Chenopodiaceae weeds: Chenopodium album, Chenopodium ambrosioides, Kochia scoparia, Salsola kali, Atriplex spp.

Amaranthaceae weeds: Amaranthus retroflexus, Amaranthus viridis, Amaranthus lividus, Amaranthus spinosus, Amaranthus hybridus, Amaranthus palmeri, Amaranthus rudis, Amaranthus patulus, Amaranthus tuberculatos, Amaranthus blitoides, Amaranthus deflexus, Amaranthus quitensis, Alternanthera philoxeroides, Alternanthera sessilis, Alternanthera tenella

Papaveraceae weeds: Papaver rhoeas, Argemone mexicana

Brassicaceae weeds: Raphanus raphanistrum, Raphanus sativus, Sinapis arvensis, Capsella bursa-pastoris, Brassica juncea, Brassica campestris, Descurainia pinnata, Rorippa islandica, Rorippa sylvestris, Thlaspi arvense, Myagrum rugosum, Lepidium virginicum, Coronopus didymus

Capparaceae weeds: Cleome affinis

Fabaceae weeds: Aeschynomene indica, Aeschynomene rudis, Sesbania exaltata, Cassia obtusifolia, Cassia occidentalis, Desmodium tortuosum, Desmodium adscendens, Trifolium repens, Pueraria lobata, Vicia angustifolia, Indigofera hirsuta, Indigofera truxillensis, Vigna sinensis

Oxalidaceae weeds: Oxalis corniculata, Oxalis strica, Oxalis oxyptera

Geraniaceae weeds: Geranium carolinense, Erodium cicutarium

Euphorbiaceae weeds: Euphorbia helioscopia, Euphorbia maculate, Euphorbia humistrata, Euphorbia esula, Euphorbia heterophylla, Euphorbia brasiliensis, Acalypha australis, Croton glandulosus, Croton lobatus, Phyllanthus corcovadensis, Ricinus communis

Malvaceae weeds: Abutilon theophrasti, Sida rhombiforia, Sida cordifolia, Sida spinosa, Sida glaziovii, Sida santaremnensis, Hibiscus trionum, Anoda cristata, Malvastrum coromandelianum

Sterculiaceae weeds: Waltheria indica

Violaceae weeds: Viola arvensis, Viola tricolor

Cucurbitaceae weeds: Sicyos angulatus, Echinocystis lobata, Momordica charantia

Lythraceae weeds: Lythrum salicaria

Apiaceae weeds: Hydrocotyle sibthorpioides

Sapindaceae weeds: Cardiospermum halicacabum

Primulaceae weeds: Anagallis arvensis

Asclepiadaceae weeds: Asclepias syriaca, Ampelamus albidus

Rubiaceae weeds: Galium aparine, Galium spurium var. echinospermon, Spermacoce latifolia, Richardia brasiliensis, Borreria alata

Convolvulaceae weeds: Ipomoea nil, Ipomoea hederacea, Ipomoea purpurea, Ipomoea hederacea var. integriuscula, Ipomoea lacunosa, Ipomoea triloba, Ipomoea acuminata, Ipomoea hederifolia, Ipomoea coccinea, Ipomoea quamoclit, Ipomoea grandifolia, Ipomoea aristolochiafolia, Ipomoea cairica, Convolvulus arvensis, Calystegia hederacea, Calystegia japonica, Merremia hedeacea, Merremia aegyptia, Merremia cissoides, Jacquemontia tamnifolia

Boraginaceae weeds: Myosotis arvensis

Lamiaceae weeds: Lamium purpureum, Lamium amplexicaule, Leonotis nepetaefolia, Hyptis suaveolens, Hyptis lophanta, Leonurus sibiricus, Stachys arvensis

Solanaceae weeds: Datura stramonium, Solanum nigrum, Solanum americanum, Solanum ptycanthum, Solanum sarrachoides, Solanum rostratum, Solanum aculeatissimum, Solanum sisymbriifolium, Solanum carolinense, Physalis angulata, Physalis subglabrata, Nicandra physaloides

Scrophulariaceae weeds: Veronica hederaefolia, Veronica persica, Veronica arvensis

Plantaginaceae weeds: Plantago asiatica

Asteraceae weeds: Xanthium pensylvanicum, Xanthium occidentale, Helianthus annuus, Matricaria chamomilla, Matricaria perforata, Chrysanthemum segetum, Matricaria matricarioides, Artemisia princeps, Artemisia vulgaris, Artemisia verlotorum, solidago altissima, Taraxacum officinale, Galinsoga ciliata, Galinsoga parviflora, Senecio vulgaris, Senecio brasiliensis, Senecio grisebachii, Conyza bonariensis, Conyza canadensis, Ambrosia artemisiaefolia, Ambrosia trifida, Bidens pilosa, Bidens frondosa, Bidens subalternans, Cirsium arvense, Cirsium vulgare, Silybum marianum, Carduus nutans, Lactuca serriola, Sonchus oleraceus, Sonchus asper, Wedelia glauca, Melampodium perfoliatum, Emilia sonchifolia, Tagetes minuta, Blainvillea latifolia, Tridax procumbens, Porophyllum ruderale, Acanthospermum australe, Acanthospermum hispidum, Cardiospermum halicacabum, Ageratum conyzoides, Eupatorium perfoliatum, Eclipta alba, Erechtites hieracifolia, Gamochaeta spicata, Gnaphalium spicatum, Jaegeria hirta, Parthenium hysterophorus, Siegesbeckia orientalis, Soliva sessilis

Liliaceae weeds: Allium canadense, Allium vineale

Commelinaceae weeds: Commelina communis, Commelina bengharensis, Commelina erecta

Poaceae weeds: Echinochloa crus-galli, Setaria viridis, Setaria faberi, Setaria glauca, Setaria geniculata, Digitaria ciliaris, Digitaria sanguinalis, Digitaria horizontalis, Digitaria insularis, Eleusine indica, Poa annua, Alospecurus aequalis, Alopecurus myosuroides, Avena fatua, Sorghum halepense, Sorghum vulgare, Agropyron repens, Lolium multiflorum, Lolium perenne, Lolium rigidum, Bromus secalinus, Bromus tectorum, Hordeum jubatum, Aegilops cylindrica, Phalaris arundinacea, Phalaris minor, Apera spica-venti, Panicum dichotomiflorum, Panicum texanum, Panicum maximum, Brachiaria platyphylla, Brachiaria ruziziensis, Brachiaria plantaginea, Brachiaria decumbens, Brachiaria brizantha, Brachiaria humidicola, Cenchrus echinatus, Cenchrus pauciflorus, Eriochloa villosa, Pennisetum setosum, Chloris gayana, Eragrostis pilosa, Rhynchelitrum repens, Dactyloctenium aegyptium, Ischaemum rugosum, Oryza sativa, Paspalum notatum, Paspalum maritimum, Pennisetum clandestinum, Pennisetum setosum, Rottboellia cochinchinensis

Cyperaceae weeds: Cyperus microiria, Cyperus iria, Cyperus odoratus, Cyperus rotundus, Cyperus esculentus, Kyllinga gracillima

Equisetaceae weeds: Equisetum arvense, Equisetum palustre, and the like.

### EXAMPLES

The present invention will be described below by way of Examples, but the present invention is not limited to these Examples.

### Example 1

Stem cuttings of sugar cane, 30 cm to 40 cm long, are placed in wet soil to stimulate germination. Stem cuttings on which a bud grows to about 1 cm long are selected and the stem cuttings are cut to have one node and a length of 3 cm. Plastic pots are filled with soil and Amaranthus retroflexus is seeded therein. The stem cuttings of sugar cane are planted in the soil in the pots at a depth of 2 cm. On the day when the stem cuttings of sugar cane are planted, after planting the stem cuttings of sugar cane, the following is uniformly sprayed on the soil surface with a sprayer: ametryn, atrazine, simazine, alachlor, metolachlor, S-metolachlor, metribuzin, trifluralin, pendimethelin, tebuthiuron, diuron, hexazinone, amicarbazone, imazapic, trifloxysulfuron-sodium, iodosulfuron-methyl-sodium, halosulfuron-methyl, ethoxysulfuron, isoxaflutole, bicyclopyrone, mesotrione, dicamba, dicamba-diglycolamine, dicamba-dimethylamine, dicamba-potassium, dicamba-sodium, or clomazon. The test pots are then placed in a greenhouse.

The herbicidal efficacy and phytotoxicity are determined four weeks after the application of the herbicides. As a result, no phytotoxicity problematic to sugar cane is observed and the control effect against the weed can be observed.

### Example 2

Plastic pots are filled with soil and Amaranthus retroflexus is seeded therein. The pots are then placed in a greenhouse to grow the weed. Three weeks after seeding the weed, the following is uniformly sprayed over the weed with a sprayer: ametryn, atrazine, simazine, asulam, metribuzin, tebuthiuron, diuron, hexazinone, amicarbazone, imazapic, trifloxysulfuron-sodium, iodosulfuron-methyl-sodium, halosulfuron-methyl, ethoxysulfuron, carfentrazone-ethyl, isoxaflutole, bicyclopyrone, mesotrione, picloram, picloram-potassium, picloram-isooctyl, picloram-tris(2-hydroxypropyl)amine, 2,4-D, 2,4-D-isooctyl, 2,4-D-ammonium, 2,4-D-dimethylamine, 2,4-D-butotyl, 2,4-D-tris(2-hydroxypropyl)amine, 2,4-D-butyl, 2,4-D-isopropyl, 2,4-D-isopropylamine, 2,4-D-diolamine, 2,4-D-dodecylamine, 2,4-D-tetradecylamine, dicamba, dicamba-diglycolamine, dicamba-dimethylamine, dicamba-potassium, dicamba-sodium, MSMA, paraquat, diquat, glufosinate-ammonium, glufosinate-P-sodium, glyphosate, glyphosate-isopropylamine, glyphosate-trimethylsulfonium, glyphosate-ammonium, glyphosate-diammonium, glyphosate-sodium, or glyphosate-potassium.

Stem cuttings of sugar cane, 30 cm to 40 cm long, are placed in wet soil to stimulate germination. Stem cuttings on which a bud grows to about 1 cm long are selected and the stem cuttings are cut to have one node and a length of 3 cm.

One week after the application of the herbicides, the stem cuttings of sugar cane are planted at a depth of 2 cm in the pots to which the herbicides have been applied. The test pots are placed in a greenhouse.

The herbicidal efficacy and phytotoxicity are determined four weeks after the application of the herbicides. As a result, no phytotoxicity problematic to sugar cane is observed and the control effect against the weed can be observed.

### Example 3

Stem cuttings of sugar cane, 30 cm to 40 cm long, are placed in wet soil to stimulate germination. Stem cuttings on which a bud grows to about 1 cm long are selected and the stem cuttings are cut to have one node and a length of 3 cm. The stem cuttings are treated with clothianidin, thiamethoxam, imidacloprid, dinotefuran, nitenpyram, acetamiprid, or thiacloprid. Plastic pots are filled with soil and Amaranthus retroflexus is seeded therein. The stem cuttings of sugar cane treated with the pesticides are planted in the soil in the pots at a depth of 2 cm. On the day when the stem cuttings of sugar cane are planted, after planting the stem cuttings of sugar cane, the following is uniformly sprayed on the soil surface with a sprayer: ametryn, atrazine, simazine, alachlor, metolachlor, S-metolachlor, metribuzin, trifluralin, pendimethalin, tebuthiuron, diuron, hexazinone, amicarbazone, imazapic, trifloxysulfuron-sodium, iodosulfuron-methyl-sodium, halosulfuron-methyl, ethoxysulfuron, isoxaflutole, bicyclopyrone, mesotrione, dicamba, dicamba-diglycolamine, dicamba-dimethylamine, dicamba-potassium, dicamba-sodium, or clomazon. The test pots are then placed in a greenhouse.

The herbicidal efficacy and phytotoxicity are determined four weeks after the application of the herbicides. As a result, no phytotoxicity problematic to sugar cane is observed and the control effect against the weed can be observed.

### Example 4

Plastic pots are filled with soil and Amaranthus retroflexus is seeded therein. The pots are then placed in a greenhouse to grow the weed. Three weeks after seeding the weed, the following is uniformly sprayed over the weed with a sprayer: ametryn, atrazine, simazine, asulam, metribuzin, tebuthiuron, diuron, hexazinone, amicarbazone, imazapic, trifloxysulfuron-sodium, iodosulfuron-methyl-sodium, halosulfuron-methyl, ethoxysulfuron, carfentrazone-ethyl, isoxaflutole, bicyclopyrone, mesotrione, picloram, picloram-potassium, picloram-isooctyl, picloram-tris(2-hydroxypropyl)amine, 2,4-D, 2,4-D-isooctyl, 2,4-D-ammonium, 2,4-D-dimethylamine, 2,4-D-butotyl, 2,4-D-tris(2-hydroxypropyl)amine, 2,4-D-butyl, 2,4-D-isopropyl, 2,4-D-isopropylamine, 2,4-D-diolamine, 2,4-D-dodecylamine, 2,4-D-tetradecylamine, dicamba, dicamba-diglyco lamine, dicamba-dimethylamine, dicamba-potassium, dicamba-sodium, MSMA, paraquat, diquat, glufosinate-ammonium, glufosinate-P-sodium, glyphosate, glyphosate-isopropylamine, glyphosate-trimethylsulfonium, glyphosate-ammonium, glyphosate-diammonium, glyphosate-sodium, or glyphosate-potassium.

Stem cuttings of sugar cane, 30 cm to 40 cm long, are placed in wet soil to stimulate germination. Stem cuttings on which a bud grows to about 1 cm long are selected and the stem cuttings are cut to have one node and a length of 3 cm. The stem cuttings are treated with clothianidin, thiamethoxam, imidacloprid, dinotefuran, nitenpyram, acetamiprid, or thiacloprid.

One week after the application of the herbicides, the stem cuttings of sugar cane treated with the pesticides are planted at a depth of 2 cm in the pots to which the herbicides have been applied. The test pots are placed in a greenhouse.

The herbicidal efficacy and phytotoxicity are determined four weeks after the application of the herbicides. As a result, no phytotoxicity problematic to sugar cane is observed and the control effect against the weed can be observed.

### Example 5

Stem cuttings of sugar cane, 30 cm to 40 cm long, are placed in wet soil to stimulate germination. Stem cuttings on which a bud grows to about 1 cm long are selected and the stem cuttings are cut to have one node and a length of 3 cm. The stem cuttings are treated with kresoxim-methyl, azoxystrobin, trifloxystrobin, fluoxastrobin, picoxystrobin, pyraclostrobin, dimoxystrobin, pyribencarb, metominostrobin, orysastrobin, enestrobin, pyraoxystrobin, or pyrametostrobin. Plastic pots are filled with soil and Amaranthus retroflexus is seeded therein. The stem cuttings of sugar cane treated with the fungicides are planted in the soil in the pots at a depth of 2 cm. On the day when the stem cuttings of sugar cane are planted, after planting the stem cuttings of sugar cane, the following is uniformly sprayed on the soil surface with a sprayer: ametryn, atrazine, simazine, alachlor, metolachlor, S-metolachlor, metribuzin, trifluralin, pendimethalin, tebuthiuron, diuron, hexazinone, amicarbazone, imazapic, trifloxysulfuron-sodium, iodosulfuron-methyl-sodium, halosulfuron-methyl, ethoxysulfuron, isoxaflutole, bicyclopyrone, mesotrione, dicamba, dicamba-diglycolamine, dicamba-dimethylamine, dicamba-potassium, dicamba-sodium, or clomazon. The test pots are then placed in a greenhouse. The herbicidal efficacy and phytotoxicity are determined four weeks after the application of the herbicides. As a result, no phytotoxicity problematic to sugar cane is observed and the control effect against the weed can be observed.

### Example 6

Plastic pots are filled with soil and Ameranthus retroflexus is seeded therein. The pots are then placed in a greenhouse to grow the weed. Three weeks after seeding the weed, the following is uniformly sprayed over the weed with a sprayer: ametryn, atrazine, simazine, asulam, metribuzin, tebuthiuron, diuron, hexazinone, amicarbazone, imazapic, trifloxysulfuron-sodium, iodosulfuron-methyl-sodium, halosulfuron-methyl, ethoxysulfuron, carfentrazone-ethyl, isoxaflutole, bicyclopyrone, mesotrione, picloram, picloram-potassium, picloram-isooctyl, picloram-tris(2-hydroxypropyl)amine, 2,4-D, 2,4-D-isooctyl, 2,4-D-ammonium, 2,4-D-dimethylamine, 2,4-D-butotyl, 2,4-D-tris(2-hydroxypropyl)amine, 2,4-D-butyl, 2,4-D-isopropyl, 2,4-D-isopropylamine, 2,4-D-diolamine, 2,4-D-dodecylamine, 2,4-D-tetradecylamine, dicamba, dicamba-diglycolamine, dicamba-dimethylam ine, dicamba-potassium, dicamba-sodium, MSMA, paraquat, diquat, glufosinate-ammonium, glufosinate-P-sodium, glyphosate, glyphosate-isopropylamine, glyphosate-trimethylsulfonium, glyphosate-ammonium, glyphosate-diammonium, glyphosate-sodium, or glyphosate-potassium.

Stem cuttings of sugar cane, 30 cm to 40 cm long, are placed in wet soil to stimulate germination. Stem cuttings on which a bud grows to about 1 cm long are selected and the stem cuttings are cut to have one node and a length of 3 cm. The stem cuttings are treated with kresoxim-methyl, azoxystrobin, trifloxystrobin, fluoxastrobin, picoxystrobin, pyraclostrobin, dimoxystrobin, pyribencarb, metominostrobin, orysastrobin, enestrobin, pyraoxystrobin, or pyrametostrobin.

The stem cuttings of sugar cane treated with the fungicides are planted at a depth of 2 cm in the pots to which the herbicides have been applied. The test pots are placed in a greenhouse.

The herbicidal efficacy and phytotoxicity are determined four weeks after the application of the herbicides. As a result, no phytotoxicity problematic to sugar cane is observed and the control effect against the weed can be observed.

### Example 7

Stem cuttings of sugar cane, 30 cm to 40 cm long, are placed in wet soil to stimulate germination. Stem cuttings on which a bud grows to about 1 cm long are selected and the stem cuttings are cut to have one node and a length of 3 cm. The stem cuttings are treated with azaconazole, bitertanol, bromuconazole, cyproconazole, difenoconazole, diniconazole, epoxiconazole, fenbuconazole, fluquinoconazole, flusilazole, flutriafol, hexaconazole, imibenconazole, ipconazole, metconazole, myclobutanil, penconazole, propiconazole, prothioconazole, simeconazole, tebuconazole, tetraconazole, triadimenol, triticonazole, fenarimol, nuarimol, pyrifenox, imazalil, oxpoconazole fumarate, peforazoate, prochloraz, or triflumizole. Plastic pots are filled with soil and Amaranthus retroflexus is seeded therein. The stem cuttings of sugar cane treated with the fungicides are planted in the soil in the pots at a depth of 2 cm. On the day when the stem cuttings of sugar cane are planted, after planting the stem cuttings of sugar cane, the following is uniformly sprayed on the soil surface with a sprayer: ametryn, atrazine, simazine, alachlor, metolachlor, S-metolachlor, metribuzin, trifluralin, pendimethalin, tebuthiuron, diuron, hexazinone, amicarbazone, imazapic, trifloxysulfuron-sodium, iodosulfuron-methyl-sodium, halosulfuron-methyl, ethoxysulfuron, isoxaflutole, bicyclopyrone, mesotrione, dicamba, dicamba-diglycolamine, dicamba-dimethylamine, dicamba-potassium, dicamba-sodium, or clomazon. The test pots are then placed in a greenhouse.

The herbicidal efficacy and phytotoxicity are determined four weeks after the application of the herbicides. As a result, no phytotoxicity problematic to sugar cane is observed and the control effect against the weed can be observed.

### Example 8

Plastic pots are filled with soil and Amaranthus retroflexus is seeded therein. The pots are then placed in a greenhouse to grow the weed. Three weeks after seeding the weed, the following is uniformly sprayed over the weed with a sprayer: ametryn, atrazine, simazine, asulam, metribuzin, tebuthiuron, diuron, hexazinone, amicarbazone, imazapic, trifloxysulfuron-sodium, iodosulfuron-methyl-sodium, halosulfuron-methyl, ethoxysulfuron, carfentrazone-ethyl, isoxaflutole, bicyclopyrone, mesotrione, picloram, picloram-potassium, picloram-isooctyl, picloram-tris(2-hydroxypropyl)amine, 2,4-D, 2,4-D-isooctyl, 2,4-D-ammonium, 2,4-D-dimethylamine, 2,4-D-butotyl, 2,4-D-tris(2-hydroxypropyl)amine, 2,4-D-butyl, 2,4-D-isopropyl, 2,4-D-isopropylamine, 2,4-D-diolamine, 2,4-D-dodecylamine, 2,4-D-tetradecylamine, dicamba, dicamba-diglycolamine, dicamba-dimethylamine, dicamba-potassium, dicamba-sodium, MSMA, paraquat, diquat, glufosinate-ammonium, glufosinate-P-sodium, glyphosate, glyphosate-isopropylamine, glyphosate-trimethylsulfonium, glyphosate-ammonium, glyphosate-diammonium, glyphosate-sodium, or glyphosate-potassium.

Stem cuttings of sugar cane, 30 cm to 40 cm long, are placed in wet soil to stimulate germination. Stem cuttings on which a bud grows to about 1 cm long are selected and the stem cuttings are cut to have one node and a length of 3 cm. The stem cuttings are treated with azaconazole, bitertanol, bromuconazole, cyproconazole, difenoconazole, diniconazole, epoxiconazole, fenbuconazole, fluquinoconazole, flusilazole, flutriafol, hexaconazole, imibenconazole, ipconazole, metconazole, myclobutanil, penconazole, propiconazole, prothioconazole, simeconazole, tebuconazole, tetraconazole, triadimenol, triticonazole, fenarimol, nuarimol, pyrifenox, imazalil, oxpoconazole fumarate, peforazoate, prochloraz, or triflumizole.

One week after the application of the herbicides, the stem cuttings of sugar cane treated with the fungicides are planted at a depth of 2 cm in the pots to which the herbicides have been applied. The test pots are placed in a greenhouse.

The herbicidal efficacy and phytotoxicity are determined four weeks after the application of the herbicides. As a result, no phytotoxicity problematic to sugar cane is observed and the control effect against the weed can be observed.

### Example 9

Stem cuttings of sugar cane, 30 cm to 40 cm long, are placed in wet soil to stimulate germination. Stem cuttings on which a bud grows to about 1 cm long are selected and the stem cuttings are cut to have one node and a length of 3 cm. The stem cuttings are treated with metalaxyl or metalaxyl-M. Plastic pots are filled with soil and Amaranthus retroflexus is seeded therein. The stem cuttings of sugar cane are planted in the soil in the pots at a depth of 2 cm. On the day when the stem cuttings of sugar cane are planted, after planting the stem cuttings of sugar cane, the following is uniformly sprayed on the soil surface with a sprayer: ametryn, atrazine, simazine, alachlor, metolachlor, S-metolachlor, metribuzin, trifluralin, pendimethalin, tebuthiuron, diuron, hexazinone, amicarbazone, imazapic, trifloxysulfuron-sodium, iodosulfuron-methyl-sodium, halosulfuron-methyl, ethoxysulfuron, isoxaflutole, bicyclopyrone, mesotrione, dicamba, dicamba-diglycolamine, dicamba-dimethylamine, dicamba-potassium, dicamba-sodium, or clomazon. The test pots are then placed in a greenhouse.

The herbicidal efficacy and phytotoxicity are determined four weeks after the application of the herbicides. As a result, no phytotoxicity problematic to sugar cane is observed and the control effect against the weed can be observed.

### Example 10

Plastic pots are filled with soil and Amaranthus retroflexus is seeded therein. The pots are then placed in a greenhouse to grow the weed. Three weeks after seeding the weed, the following is uniformly sprayed over the weed with a sprayer: ametryn, atrazine, simazine, asulam, metribuzin, tebuthiuron, diuron, hexazinone, amicarbazone, imazapic, trifloxysulfuron-sodium, iodosulfuron-methyl-sodium, halosulfuron-methyl, ethoxysulfuron, carfentrazone-ethyl, isoxaflutole, bicyclopyrone, mesotrione, picloram, picloram-potassium, picloram-isooctyl, picloram-tris(2-hydroxypropyl)amine, 2,4-D, 2,4-D-isooctyl, 2,4-D-ammonium, 2,4-D-dimethylamine, 2,4-D-butotyl, 2,4-D-tris(2-hydroxypropyl)amine, 2,4-D-butyl, 2,4-D-isopropyl, 2,4-D-isopropylamine, 2,4-D-diolamine, 2,4-D-dodecylamine, 2,4-D-tetradecylamine, dicamba, dicamba-diglycolamine, dicamba-dimethylamine, dicamba-potassium, dicamba-sodium, MSMA, paraquat, diquat, glufosinate-ammonium, glufosinate-P-sodium, glyphosate, glyphosate-isopropylamine, glyphosate-trimethylsulfonium, glyphosate-ammonium, glyphosate-diammonium, glyphosate-sodium, or glyphosate-potassium.

Stem cuttings of sugar cane, 30 cm to 40 cm long, are placed in wet soil to stimulate germination. Stem cuttings on which a bud grows to about 1 cm long are selected and the stem cuttings are cut to have one node and a length of 3 cm. The stem cuttings are treated with metalaxyl or metalaxyl-M.

One week after the application of the herbicides, the stem cuttings of sugar cane treated with the fungicides are planted at a depth of 2 cm in the pots to which the herbicides have been applied. The test pots are placed in a greenhouse.

The herbicidal efficacy and phytotoxicity are determined four weeks after the application of the herbicides. As a result, no phytotoxicity problematic to sugar cane is observed and the control effect against the weed can be observed.

### INDUSTRIAL APPLICABILITY

The method of the present invention can control weeds in a sugar cane field without causing phytotoxicity problematic to sugar cane. The method of the present invention can also increase the yield of sugar cane to increase the amount of sugar produced.

1. A method for controlling weeds in a sugar cane field, comprising applying at least one herbicide selected from the group consisting of ametryn, atrazine, simazine, alachlor, metolachlor, S-metolachlor, asulam, metribuzin, trifluralin, pendimethalin, tebuthiuron, diuron, hexazinone, amicarbazone, imazapic, trifloxysulfuron-sodium, iodosulfuron-methyl-sodium, halosulfuron-methyl, ethoxysulfuron, carfentrazone-ethyl, isoxaflutole, bicyclopyrone, mesotrione, picloram and salts and esters thereof, 2,4-D and salts thereof and esters thereof, dicamba and salts and esters thereof, clomazone, MSMA, paraquat, diquat, glufosinate and salts thereof, glufosinate-P and salts thereof, and glyphosate and salts thereof,
to a field before or after planting stem cuttings of sugar cane having only one node.

2. The method for controlling weeds in a sugar cane field according to claim 1, wherein the stem cuttings of sugar cane have a length of from 2 cm to 15 cm.

3. The method for controlling weeds in a sugar cane field according to claim 1, wherein the stem cuttings of sugar cane have a length of from 3 cm to 8 cm.
